(19) United States
(12) Patent Application Publication
(10) Pub. No.: US 2014/0073377 A1
(43) Pub. Date: Mar. 13, 2014

(54) PROTECTIVE CASE FOR PORTABLE ELECTRONIC DEVICES

(71) Applicant: DAVID CHANG, Houston, TX (US)

(72) Inventor: DAVID CHANG, Houston, TX (US)

(21) Appl. No.: 14/025,636

(22) Filed: Sep. 12, 2013

Related U.S. Application Data
(60) Provisional application No. 61/700,143, filed on Sep. 12, 2012.

(51) Int. Cl. H04B 1/38; B65D 81/02

(52) U.S. Cl. CPC H04B 1/3888; B65D 81/022
USPC 455/575.8; 206/37

(57) ABSTRACT

The present application is directed to a protective case for housing an electronic device including a front cover member defined by an outer surface and an inner surface and a back cover member having an outer surface and an inner surface defining a first thickness of the back cover member, the inner surface including one or more raised surface areas defining a second thickness of the back cover member along a predetermined pattern.

### CROSS-REFERENCE TO RELATED APPLICATIONS

This application claims the benefit of provisional patent application No. 61/700,143 filed on Sep. 12, 2012.

### STATEMENT REGARDING FEDERALLY SPONSORED RESEARCH OR DEVELOPMENT

Not applicable.

### FIELD OF THE APPLICATION

The application relates generally to protective type cases for portable electronic devices.

### BACKGROUND

Protective cases are often used with items such as portable electronic devices to protect the devices against damage resulting from various impacts, e.g., dropping, scratching or hitting the device. There are many types of portable electronic devices that employ protective cases including, but not necessarily limited to personal digital assistants (PDAs), computers, smartphones, mobile phones, notebooks, calculators, satellite phones, cellular phones, pagers, music player, MP3 players, media players, digital cameras, video cameras, bar code scanner, global positioning systems (GPS), and portable game consoles. Known protective cases are often constructed using multiple layers resulting in very bulky or cumbersome protective cases to ensure case integrity to protect the device housed therein. In addition, electronic devices that employ user interfaces such as touch screens are typically housed within protective cases in a manner resulting in gaps between the touch screen of the electronic device and the touch screen cover portion of the protective device. Gaps often result in less than desired touch screen responsiveness during use.

A protective case that overcomes the above shortcomings is desired.

### SUMMARY

The present application is directed to A protective case for housing an electronic device including a front cover member defined by an outer surface and an inner surface and a back cover member having an outer surface and an inner surface defining a first thickness of the back cover member, the inner surface including one or more raised surface areas defining a second thickness of the back cover member along a predetermined pattern.

The present application is also directed to a protective case for housing a smart phone having a touch screen user interface including (1) a front cover member having an interactive cover section defined by an inner surface and an outer surface; (2) a back cover member having an outer surface and an inner surface defining a first thickness of the back cover member, the inner surface including one or more raised surface areas defining a second thickness of the back cover member along a predetermined pattern; and (3) one or more spacer members attached to the inner surface of the back cover member, the one or more space members being operationally configured to maintain the touch screen in operative communication with the outer surface of the interactive cover.

### DESCRIPTION OF THE FIGURES

FIG. 1 is a perspective view of an empty protective case suitable for housing a portable electronic device.

FIG. 2 is a perspective view of a protective case housing a portable electronic device, the user interface of the portable electronic device lying in substantial contact with the interactive cover of the protective case.

FIG. 3 is a view of the inner surface of the second member of an embodiment of the protective case.

FIG. 4 is a view of the outer surface of the second member of an embodiment of the protective case.

FIG. 5 is a view of the inner surface of the second member of another embodiment of the protective case.

FIG. 6A is a view of the inner surface of the second member of another embodiment of the protective case.

FIG. 6B is a view of the inner surface of the second member of another embodiment of the protective case.

FIG. 6C is a view of the inner surface of the second member of another embodiment of the protective case.

FIG. 6D is a view of the inner surface of the second member of another embodiment of the protective case.

### DESCRIPTION

It has been discovered that a protective case for portable electronic devices may be provided that minimizes size requirements of the protective case while maintaining or improving both (1) structural integrity and/or strength of the protective case against impacts and (2) user interface sensitivity of the device housed therein. Heretofore, such a desirable achievement has not been considered possible, and accordingly, the protective case, system and method of this application measure up to the dignity of patentability and therefore represents a patentable concept.

Before describing the invention in detail, it is to be understood that the present device, system and method are not limited to particular embodiments. It is also to be understood that the terminology used herein is for the purpose of describing particular embodiments only, and is not intended to be limiting. As used in this specification and the appended claims, the term “user interface” refers to the location(s) on a portable electronic device where interaction between humans and a portable electronic device occurs.

In one aspect, the application provides a case having a lower member and an upper member that may be assembled in a manner effective to house a portable electronic device therein. Suitably, at least one member is reinforced structurally by increasing the thickness of the member at one or more points.

In another aspect, the application provides a two-part protective case for housing a portable electronic device, the protective case being operationally configured to maintain its structural integrity against collapsing inward toward the electronic device housed therein by providing a back cover having increases areas of thickness along a predetermined pattern.

In another aspect, the application provides a protective case including a back cover member characterized by a grid like pattern forming channels therein. The grid like pattern may be operationally configured to receive one or more rigid and/or semi-rigid and/or resilient materials and/or semi-resilient materials within the channels. The materials received within the channels provide a raised surface of the back cover. The height of the materials received within the channels may be determined based on the size characteristics of a portable electronic device to be housed within the protective case and/or the volume of a protective case in a closed position.

In another aspect, the protective case may include a back cover and a front cover for housing a portable electronic device therein. The back cover may include a single layer of construction material with an inner surface defined by non-intersecting raised sections of construction material for reinforcing the back cover and providing a support surface for an electronic device housed within the portable case. In another aspect, the back cover may include a single layer of construction material with an inner surface defined by intersecting raised sections of construction material for reinforcing the back cover and providing a support surface for an electronic device housed within the portable case.

In another aspect, the application provides a protective case operationally configured to maintain its structural integrity against collapsing inward toward the electronic device housed therein by providing a back cover having increases areas of thickness along a predetermined pattern. The protective case may further include one or more sealable apertures there through operationally configured to work in conjunction with features including, but not necessarily limited to camera lenses, camera flashes, global positioning system (“GPS”) antennas, speakers, receivers, and combinations thereof typically found on commercially available portable electronic devices including, but not necessarily limited to smartphones and tablets.

In another aspect, the application provides a protective case and method for providing abutment of a smartphone touch screen against the inner surface of an interactive cover of a protective case by providing a protective case having a back cover characterized by raised sections and/or other raised members attached thereto for contacting the back side of a smartphone in a manner effective to maintain the touch screen of the smartphone in substantial abutment against the interactive cover of the front cover during use.

In another aspect, the application provides a protective case operationally configured to provide shock absorption and/or vibration dampening against a force or shock originating in any direction.

In another aspect, the application provides a protective case for electronic devices (including mobile phones such as smart phones) having an internal grid-like pattern structure operationally effective to provide both extra strength and better touch screen sensitivity during operation. A grid-like pattern structure is effective to guard against collapsing of the protective case parts into electronic device housed therein. Inside one or more of the open areas of the grid-like pattern are calculated placed pads operationally configured to maintain the user interface of the electronic device closer to the screen protection region of the protective case.

### Discussion

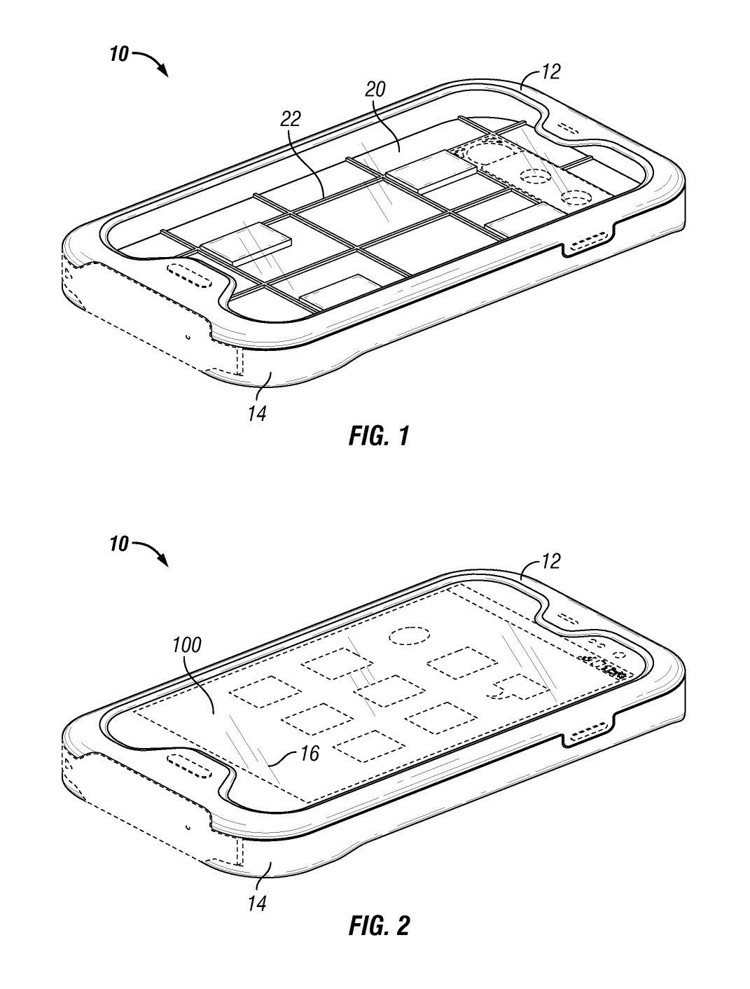

To better understand the novelty of the protective case and method of use thereof, reference is hereafter made to the accompanying drawings. Generally, a simplified protective case 10 is provided in FIGS. 1 and 2. As shown, the protective case 10 suitably includes a first member 12 operationally configured to cover the front surface of a portable electronic device and a second member 14 operationally configured to cover the back surface of a portable electronic device. During operation, the first and second members 12, 14 suitably (1) seal or otherwise house a device 100 therein and (2) substantially abut a user interface, e.g., a touch screen of a computer, smartphone, tablet, or similar device, against the interactive cover 16 of the first member 12 as shown in FIG. 2. In one embodiment, a suitable interactive cover 16 is operationally configured for seamless use of a user interface of the device 100 housed within the protective case 10. For example, in an embodiment where the user interface is a touch screen, a suitable interactive cover 16 is operationally configured for seamless use of capacitive and resistive type touch screens as known in the art of portable electronic devices.

As understood by the skilled artisan, capacitive sensors make use of the human body's natural capacitance, which is its ability to store and conduct a minimal electric charge. As an example, in a computer, smartphone or tablet touch screen, the human touch interrupts the electrostatic field of the touch screen, sending a signal to the processor inside the device 100. When the processor receives the signal, the processor initiates the appropriate action as indicated by the user's input. Rather than a flexible two-layer design, capacitive touch screens typically have a single layer of glass as their touch interface. Its reliance on charge rather than on pressure facilitates multi-touch functionality, meaning that if users have more than one finger on the screen, the device can recognize and respond to both. As also understood by the skilled artisan, resistive touch screens function due to pressure from a stylus, a finger, a fingernail, or any other hard or substantially solid object. Although this type of technology can be very precise, it lacks multi-touch functionality. Users may touch the screen with more than one finger or stylus, but the screen will only recognize the first object that came into contact with it.

Depending on the type of user interface employed for a particular device 100, suitable interactive covers 16 suitably include substantially clear or transparent members constructed from one or more materials effective for operation of the touch screen of the device 100 upon contact by users along the outer surface of the interactive cover 16. Thus, in one implementation making use of a resistive touch screen, direct contact by a user along the outer surface of the interactive cover 16 at one or more particular locations results in a touching or triggering of targeted locations along corresponding location(s) of the touch screen of the device 100 housed within the protective case 10. In an implementation of the protective case 10 for use with capacitive touch screens, the interactive cover 16 is suitably constructed from one or more materials effective to allow for the interruption of the electrostatic field of the touch screen upon human touch on or near the outer surface of the interactive cover 16.

Suitable interactive cover 16 materials may include, but are not necessarily limited to glass, acrylic glass, thermoplastic polymers. A suitable thermoplastic polymer includes, but is not necessarily limited to polyethylene terephthalate. For use with interfaces such as computer touch screens, smartphone touch screens, tablet touch screens, and the like, interactive covers 16 suitably have a thickness from about 0.05 mm (about 0.002 inches) to about 0.8 mm (about 0.031 inches).

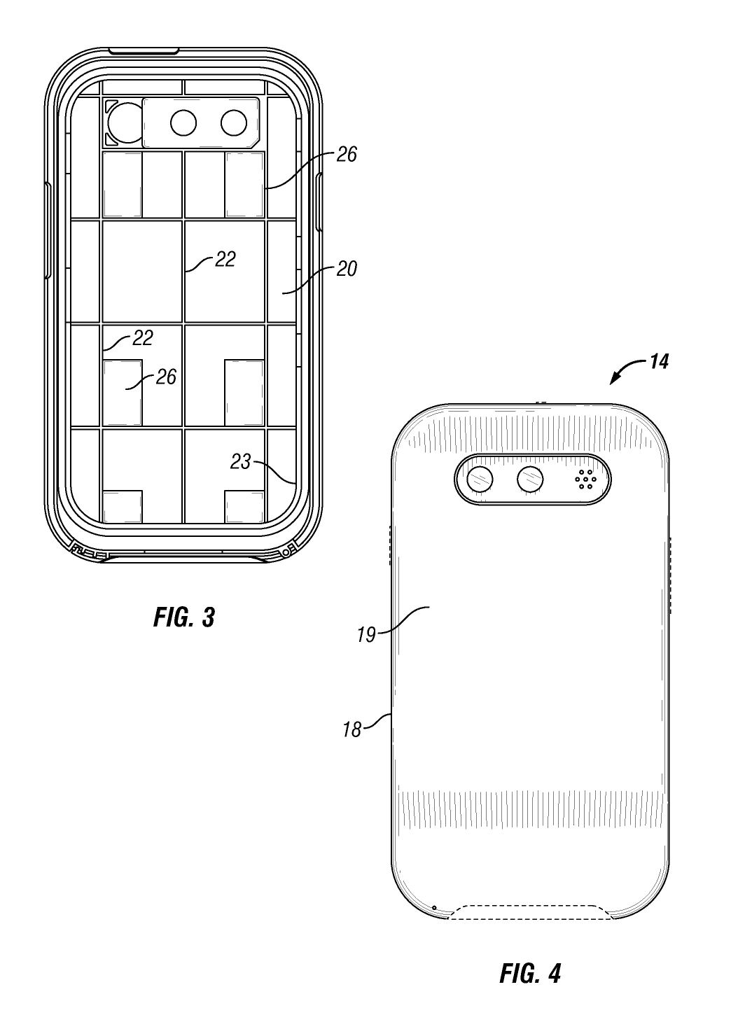

Turning to FIGS. 3-4, the second member 14 suitably includes an outer cover 18 defined by an outer surface 19 and an inner surface 20. As shown, the inner surface 20 includes one or more raised surfaces 22 operationally configured to support a portable electronic device 100 (hereafter discussed in terms of a smartphone) apart from the inner surface 20 during use. Suitably, the one or more raised surfaces 22 are operationally configured to provide structural integrity, strength or rigidity to the second member 14 while minimizing (1) the thickness of the protective case 10 by minimizing the wall thickness of the second member 14 and (2) the width of the protective case 10 by minimizing the wall thickness of the perimeter of the second member 14. For example, in an embodiment where the second member 14 is provided as a plastic molded one piece construction, the raised surfaces 22 provide areas of increased thickness of the outer cover 18 of the second member 14 in comparison to the remaining outer cover 18 of the second member 14. In one embodiment, the thickness of the outer cover 18 of the second member 14 may be uniform along the raised surfaces 22. In another embodiment, the thickness of the outer cover 18 of the second member 14 may vary along the raised surfaces 22. Suitably, the thickness of the outer cover 18 of the second member 14 at a raised surface 22 is up to about 80.0% greater than the thickness of the second member 14 at the inner surface 20 adjacent thereto. Although the protective case 20 may be built to scale, in one embodiment of a protective case 10 operationally configured to house a smartphone 100 as commercially available at the time of this application, the thickness of the outer cover 18 at the inner surface 20 is about 1.8 mm (about 0.07 inches) and the thickness of the second member 14 at a raised surface 22 is about 4.3 mm (about 0.17 inches)—about a 139.0% increase in thickness of the outer cover at the raised surface 22 compared to the thickness of the outer cover at the inner surface 20.

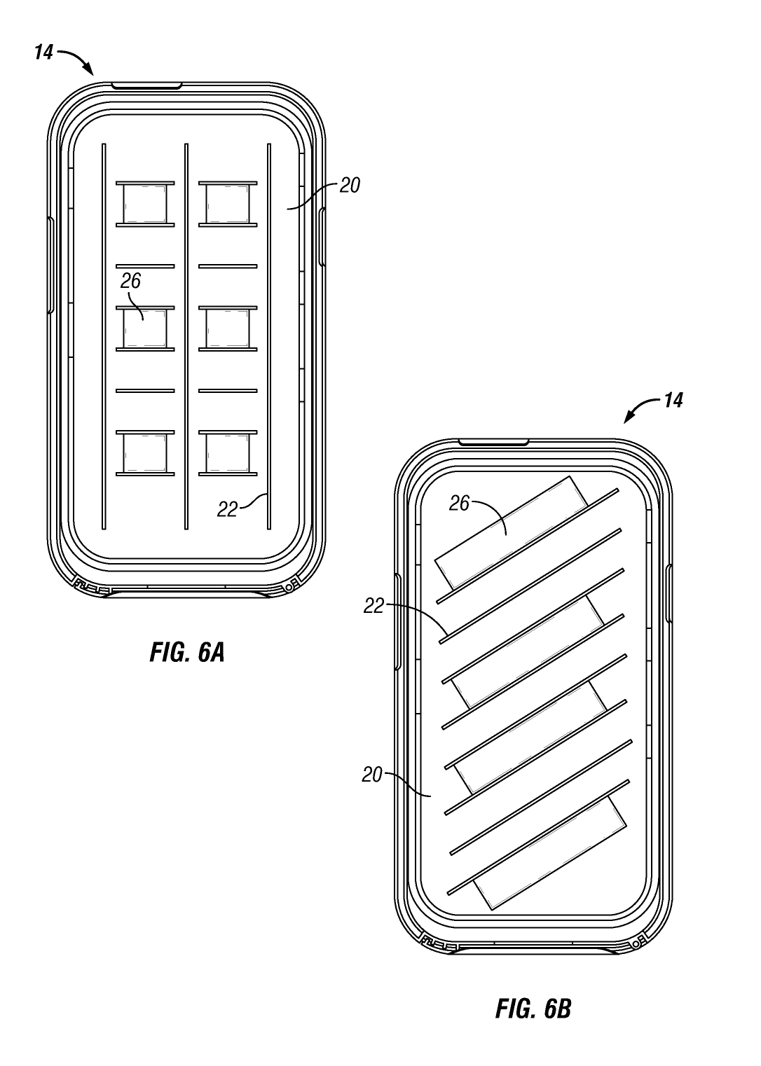

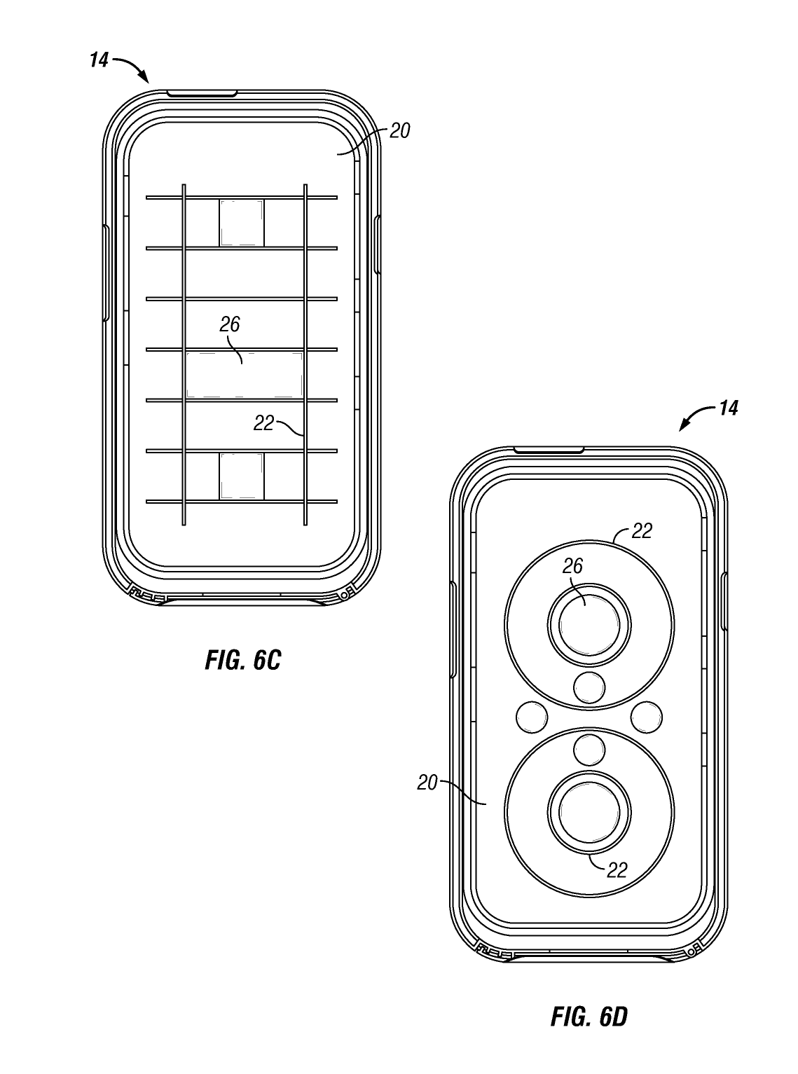

In the simplified embodiment of FIG. 3, the raised surfaces 22 are provided in a grid like pattern including linear raised surfaces 22 running lengthwise end to end and side to side in an intersecting orientation. Grid lines may be spaced as desired. Suitably, grid lines for any particular protective case 10 are spaced in a manner effective to provide structural integrity to the second member 14 for a particular type of smartphone 100. Other raised surface 22 patterns effective to provide structural integrity to the second member 14 and to the protective case 10 during operation may also be employed (see the simplified illustrations of raised surface 22 patterns in FIGS. 6A-6D). For example, raised surfaces 22 may be provided as non-intersecting members or substantially parallel members disposed from a first end of the inner surface 20 of the second member 14 to a second end of the inner surface 20 of the second member 14 or provided as non-intersecting members or substantially parallel members disposed from a first side to a second side of the second member 14 as desired.

Raised surfaces 22 may be disposed along various points of the inner surface 20 of a second member 14. As shown in FIG. 3, the second member 14 may be provided as a plastic molded one piece construction whereby the raised surfaces 22 are in material communication with a perimeter member 23 defining the border of the inner surface 20 of the second member 14. In another embodiment, the raised surfaces 22 are constructed from materials different than the remainder of the second member 14. As desired, the raised surfaces 22 may comprise up to about 15.0% of the surface area of the inner surface 20. Without limiting the invention, at least about 3.0% of the surface area of a smart phone 100 housed within a protective case 10 suitably contacts the raised surfaces 22 during operation of the protective case 10.

Regardless of the configuration of the one or more raised surfaces 22 employed, an advantageous raised surface 22 pattern is operationally configured to guard against collapsing or other deformation of the protective case 10 during operation. In particular, the one or more raised surfaces 22 are operationally configured to improve the tensile strength and/or the yield strength and/or the shear strength of the second member 14 as compared to a similar second member 14 absent or empty of raised surfaces 22.

The width of the raised surfaces 22 may also vary as desired. In one embodiment, the raised surfaces 22 may include a uniform width. In another embodiment, the raised surfaces 22 may include varying widths. Concerning a protective case 10 designed to house a smart phone, the width of the raised surfaces 22 may range from about 1.0 mm (about 0.039 inches) to about 5.0 mm (about 0.20 inches). In the simplified embodiment of FIG. 3 operationally configured to house a smart phone 100, the raised surfaces 22 include a substantially uniform width of about 1.0 mm (about 0.039 inches). Width requirements and height requirements of raised surfaces 22 may vary according to characteristics of the target device 100 to be housed within the protective case 10 including, but not necessary limited to the weight of the device 100, the location of any sensitive electronic components along the device, and combinations thereof. Width requirements and height requirements of raised surfaces 22 may also vary according to the material(s) of construction of the protective case 10 or at least the material(s) of construction of the second member 14. For example, a stronger material of construction of the second member 14 may require raised surfaces 22 of a width less than the width of raised surfaces 22 of a second member 14 constructed from one or more materials less strong or durable.

With further attention to FIG. 3, the second member 14 may be provided with one or more pads 26 (or spacer members) operationally configured to maintain a front surface of a device 100, e.g., a touch screen or other user interface of a device 100, (1) in substantial abutment against the interactive cover 16 of the first member 12 and/or (2) in operative communication with the outer surface of the interactive cover 16 as desired according to the capacitive and resistive type user interfaces commercially available at the time of the filing of this application without having to increase the thickness of substantially the entire outer cover 18. In one embodiment, the spacer members 26 may accomplish one or more of the above listed functions alone. In another embodiment, the spacer members 26 may act in conjunction with the raised surfaces 22 to maintain a user interface of a device 100 (1) in substantial abutment against the interactive cover 16 of the first member 12 and/or (2) in operative communication with the outer surface of the interactive cover 16. Said another way, the one or more spacer members 26 are operationally configured to maintain a user interface of a device 100 substantially adjacent an interactive cover 16 during operation. For the purposes of this application, the phrase “substantially adjacent” may include direct contact as well as slight spacing there between. As such, a user may interact with the user interface with minimal or zero interference according to the capacitive and resistive type user interface of a particular device 100 housed within the protective case 10.

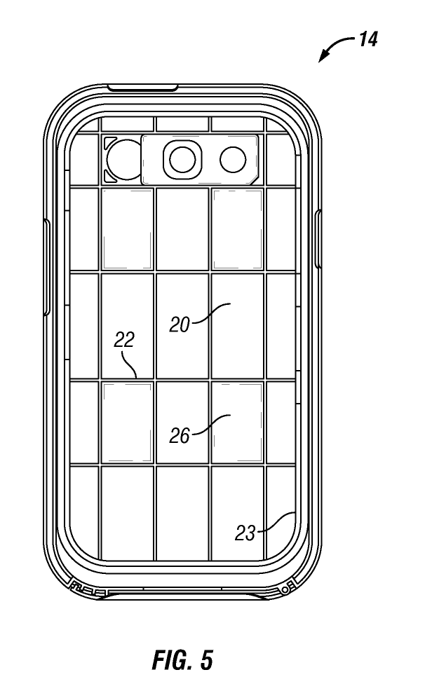

As shown in FIG. 3, the spacer members 26 may be located along the inner surface 20 in a manner effective to contact the device 100 near opposing ends and sides of the device 100 to be housed therein. As shown in FIG. 5, the spacer members 26 may be sized to substantially cover or fill one or more particular grid boxes abutting the raised portions 22 defining the perimeter thereof. The spacer members 26 employed may have any suitable size and/or shape. Each spacer member 26 may be substantially identical in size and shape to the remaining spacer members 26. In another embodiment, one or more spacer members 26 may include a different size and shape from the remaining spacer members 26. In addition, the spacer members 26 may be arranged in any suitable manner and any desired quantity of spacer members 26 may be used for a particular embodiment of the protective case 10. It is further contemplated that the spacer members 26 may be permanently or removably attached to the inner surface 20 of the second member 14 as desired. For example, spacer members 26 may be attached to the second member 14 via fasteners, adhesives, mechanical engagement, and combinations thereof. In one embodiment, the spacer members 26 may cover from about 2.0% to about 85.0% of the surface area of the inner surface 20. In another embodiment, the spacer members 26 may cover from about 3.0% to about 80.0% of the surface area of the inner surface 20. In still another embodiment, the spacer members 26 may cover from about 5.0% to about 10.0% of the surface area of the inner surface 20.

In addition, the one or more spacer members 26 may be constructed from one or more materials operationally configured to provide shock absorbing and/or vibration dampening qualities to the protective case 10. Suitable spacer member 26 materials may include, but are not necessarily limited to polymer materials, cork, leather, textiles, and combinations thereof. Suitably polymer materials may include, but are not necessarily limited to rubbers, plastics, foam, and combinations thereof. In addition, the height of the one or more spacer members 26 relative to the inner surface 20 may be less than, greater than or equal to the height of corresponding raised surfaces 22 relative to the inner surface 20. In the simplified embodiment of the protective case of FIG. 3 operationally configured to house a smart phone 100, the one or more spacer members 26 may be constructed from polyurethane having a height relative to the inner surface 20 about equal to the height of the sections of raised surfaces 22 adjacent the side edges of the pads 26. In another embodiment, the one or more spacer members 26 may be constructed from polyurethane having a height relative to the inner surface 20 about equal to the height of the sections of substantially entire raised surfaces 22.

Suitably, the protective case 10 may be constructed from one or more materials durable enough to operate as described above. More particularly, the protective case 10 may be constructed of materials including but not necessarily limited to those materials resistant to chipping, cracking, excessive bending and reshaping as a result of ozone, weathering, heat, moisture, other outside mechanical and chemical influences, as well as external impacts and other loads placed on the protective case 10. Likewise, the protective case 10 may comprise any color or combination of colors, or in the alternative, the protective case 10 may be transparent, translucent or opaque as desired.

Suitable protective case 10 materials may include rigid and semi-rigid materials. Without limiting the invention, suitable materials of construction may include, but are not necessarily limited to metals, woods, plastics, rubbers, ceramics, filled composite materials, carbon fiber, and combinations thereof. Suitable plastics may include, but are not necessarily limited to thermoset plastics and thermoplastics such as polyurethane, polypropylene, polyethylene and copolymers thereof and engineering thermoplastics such as acrylonitrile butadiene styrene (ABS), polycarbonate, polyamides (e.g. Nylon), polysulphone, polybutylene terephthalate (PBT), polyethylene terephthalate (PET). Plastics may also include composite materials, for example, plastics containing inorganic or organic fillers and/or high aspect ratio reinforcements, e.g., fiberglass, carbon fibers, graphite fibers. Plastics may also be cross-linked by conventional means to control stiffness of the final part. As stated above, thermosets can also be used such as epoxy resins, phenolic resins including composites of these resins withfillers and reinforcements as desired. In one particular embodiment, the protective case 10 may be constructed from thermoplastic polyurethane. Suitable metals may include, but are not necessarily limited to metal alloys such as aluminum, titanium, copper, brass, nickel alloy, stainless steel, carbon steel, and combinations thereof.

Depending on the materials of construction, the protective case 10 may be produced by, for example, 3-D printing technology, assembly of component parts, machining, e.g., via computer numerical control (CNC), blow molding, injection molding, injection blow molding, vacuum forming, thermoforming, and combinations thereof. Also, the various individual protective case 10 parts may be constructed from different materials and/or by different processes, as desired.

The invention will be better understood with reference to the following non-limiting example, which is illustrative only and not intended to limit the present invention to a particular embodiment.

### Example 1

A protective case 10 as shown in FIGS. 1 and 2 is provided that is operationally configured for housing a SAMSUNG GALAXY S®4 smartphone commercially available from Samsung Electronics Co., Ltd., at the time of this application. The SAMSUNG GALAXY S®4 smartphone has the following outer dimensions:

Thickness: about 7.9 mm (about 0.311 inches)

Width: about 69.8 mm (about 2.75 inches)

Height: about 136.6 mm (about 5.38 inches)

When the SAMSUNG GALAXY S®4 smartphone is housed within the protective case 10 during operation, the protective case 10 has the following outer dimensions:

Thickness: about 15.0 mm (about 0.59 inches)

Width: about 79.2 mm (about 3.12 inches)

Height: about 151.5 mm (about 5.96 inches)

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

I claim:

1. A protective case for housing an electronic device including:
a front cover member defined by an outer surface and an inner surface and a back cover member having an outer surface and an inner surface defining a first thickness of the back cover member, the inner surface including one or more raised surface areas defining a second thickness of the hack cover member along a predetermined pattern.

2. The protective case of claim 1 wherein the raised surface areas define a grid-like pattern.

3. The protective case of claim 1 further including a perimeter member defining the border of the inner surface.

4. The protective case of claim 3 wherein the raised surface areas are in material communication with the perimeter member.

5. The protective case of claim 1 further including one or more spacer members attached to the inner surface of the back cover member, the one or more spacer members being operationally configured to maintain a front surface of an electronic device in substantial abutment against the inner surface of the front covet.

6. The protective case of claim 5 wherein the one or more spacer members cover from about 2.0% to about 85.0% of the surface area of the inner surface of the back cover member.

7. The protective case of claim 5 wherein the one or more spacer members may be constructed from materials selected from the group consisting of polymer materials, cork, leather, textiles, and combinations thereof.

8. The protective case of claim 1 wherein the back cover member has a thickness at the raised surface areas about a 139.0% greater than the thickness of the back cover member at the inner surface.

9. A protective case for housing a smart phone having a touch screen user interface including:
a front cover member having an interactive cover section defined by an inner surface and an outer surface;
a back cover member having an outer surface and an inner surface defining a first thickness of the back cover member, the inner surface including one or more raised surface areas defining a second thickness of the hack cover member along a predetermined pattern; and
one or more spacer members attached to the inner surface of the bock cover member, the one or more space members being operationally configured to maintain the touch screen in operative communication with the outer surface of the interactive cover.
